(19) United States
(12) Patent Application Publication
(10) Pub. No.: US 2007/0033152 A1
(43) Pub. Date: Feb. 8, 2007

(54) Digital signal processing device

(75) Inventors: Alois Hahn, Vienna (AT); Premsyl Vaclavik, Vienna (AT); Heinz Gerald Krottendorfer, Vienna (AT); Christian Tiringer, Bisamberg (AT)

Correspondence Address: LERNER GREENBERG STEMER LLP, P O BOX 2480, HOLLYWOOD, FL, 33022-2480, US

(73) Assignee: On Demand Microelectronics, GmbH

(21) Appl. No.: 10/571,021

(22) PCT Filed: Sep. 7, 2004
(86) PCT No.: PCT/AT04/00305

§ 371 Date: May 15, 2006

(30) Foreign Application Priority Data
Sep. 8, 2003 (AT) A 1402/2003

(51) Int. Cl. G06F 17/00

(52) U.S. Cl. 705/500

(57) ABSTRACT

The invention relates to a digital signal processing device comprising: input storage means (3; 5); a computational device (4) that is connected to said means, defines a data path (9) and contains at least one arithmetic unit (6) in addition to a control input (2a) for specifying calculation operations; and output storage means (8). The data path (9) between the arithmetic unit (6; 7) and the output storage means (8) is equipped with a number-format conversion unit (10) comprising a shift unit (17). A number-format specification unit (11) and a control unit (17), which is connected to the latter and calculates required shift operations on the basis of the number-format specification, are assigned to the number-format conversion unit (10). Formatting operations are calculated automatically using input and output format information and corresponding commands are applied to the shift unit (17).

The invention relates to a digital signal processing device, in particular a digital computing device, according to the introductory clause of claim 1.

In digital signal processing, digital signals are treated digitally by applying the most varied algorithms, the digital signals being derived, for example, from originally analog signals by means of sampling. The signal processing can be performed in the form of calculations in accordance with communication algorithms in order to implement, for example, a band-pass filter or the like. For such digital signal processing, the digital signal values are stored in binary form in storage means, the values mostly being stored in a 2's complement representation as integral number or as fixed-point number. In certain applications, the more elaborate floating-point format can also be used.

To carry out the digital signal processing, digital signal processors (DSP) are used in most cases, in the case of applications with very high rates of throughput such as, for example, during image compression or in DSL technology (digital subscriber line), special tailor-made arithmetic units are also used which allow much higher computing speeds.

During the signal processing, a format conversion is frequently needed, i.e. the number representation must be changed with regard to the desired accuracy. In this context, it is typical that the number of bits used, i.e. the bit width of the data words, is increased for higher accuracy, and following that a reduction is again required and, moreover, the position of the decimal point must also be aligned with these format changes. In these format conversions and decimal point alignments, numerical errors occur, naturally, which have a subsequent effect on the accuracy of the result and thus on the quality of the output signal; the reduction in the quality of the output signal can be noticed, for example, as signal noise in communication applications and, e.g. in the case of the implementation of integrating filters, a total failure of these filters can be caused.

Accordingly, the precise format conversion and, if necessary, also correct rounding in signal terms are very critical aspects during such digital signal processing, these manipulations, moreover, occurring frequently in the usual practical applications in addition to the actual mathematical calculations such as multiplying or adding. Accordingly, such format conversion also has significant effects on the achievable processing speeds, i.e. on the clock frequency which can be achieved in each case, which also determines the technical and economical feasibility in consequence.

In the signal processors currently used and known, respectively, format alignments and roundings are performed as programs with the aid of a number of individual commands, the performance of these commands requiring a number of clock cycles; in some cases, the number of clock cycles needed for this purpose can be greater than the number of clock cycles for the actual algorithmic signal processing or calculation which, naturally, is particularly disadvantageous.

From U.S. Pat. No. 4,041,461, U.S. Pat. No. 4,876,660 and U.S. Pat. No. 5,844,827, processor devices are known in which reformatting is also performed during signal processing events. In the known techniques, however, the information for reformatting is actually predetermined in advance due to corresponding programming via a control processor, and stored in a register, i.e., the respective shift operations must be specified in detail by programming, a change to other number formats requiring corresponding new programming inputs. These known techniques are thus rigid and awkward with regard to format changes.

It is then the object of the invention to provide for particularly efficient processing of digital signals by using flexible number format conversions and possibly rounding operations, wherein, in particular, it is intended to enable an arbitrarily specifiable format conversion to be performed within a single clock cycle, and that within the same step as the actual mathematical operations.

To achieve this object, the invention provides a digital signal processing device having the features of claim 1. Particularly advantageous embodiments and developments are defined in the subclaims.

According to the invention, according to a particularly preferred aspect, a special format conversion unit, preferably with a rounding unit, is directly integrated into the data path of the arithmetic unit. Any format conversions and possibly rounding operations thus become an immediate component for each signal processing command so that, as a rule, no separate clock cycle is needed. A further advantage lies in the fact that the program generation is greatly simplified since the programmer is automatically relieved of the problems in connection with the format conversion. The number format conversion unit, possibly with the integrated rounding unit, does not need to be designed for a predetermined format, instead, a format specification or adjustment is possible with particular advantage, for which purpose a format register is preferably provided as format specification unit.

Depending on requirements, this format register is loaded once and after that determines the format conversions and roundings and thus the precise operation of these units due to its content. In particular, the format register contains fields for determining the data format, like the number of positions overall and the number of positions after the decimal point, and this both for the initial format and for the target format.

Furthermore, a clipping function can also be integrated into the number format conversion unit in order to prevent a signal value from overflowing into the wrong sign when the maximum value is exceeded. Integrating such a clipping function, i.e. installing a clipping unit in the format conversion unit, also has the result that no additional clock cycle is needed and, as mentioned, errors which may in certain circumstances occur in connection with the format conversion and rounding function, are prevented by this clipping function. A comparable clipping function is also preferably allocated to the rounding unit in order to thus detect any overflow during a rounding up and to supply the correct result.

In the text which follows, the invention will be explained in further detail by means of preferred exemplary embodiments to which, however, it should not be restricted. In detail, in the drawing:

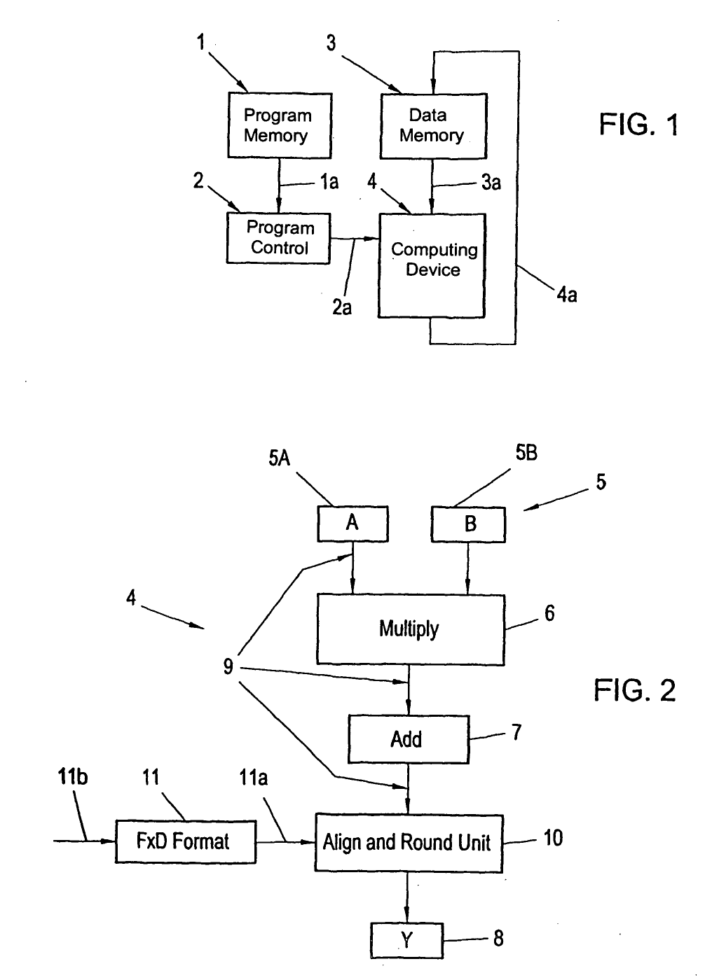

FIG. 1 shows a block diagram of a signal processor known per se;

FIG. 2 shows a diagrammatic block diagram of an arithmetic unit of such a processor, namely with a number format conversion unit according to the invention, to which a format specification unit is allocated;

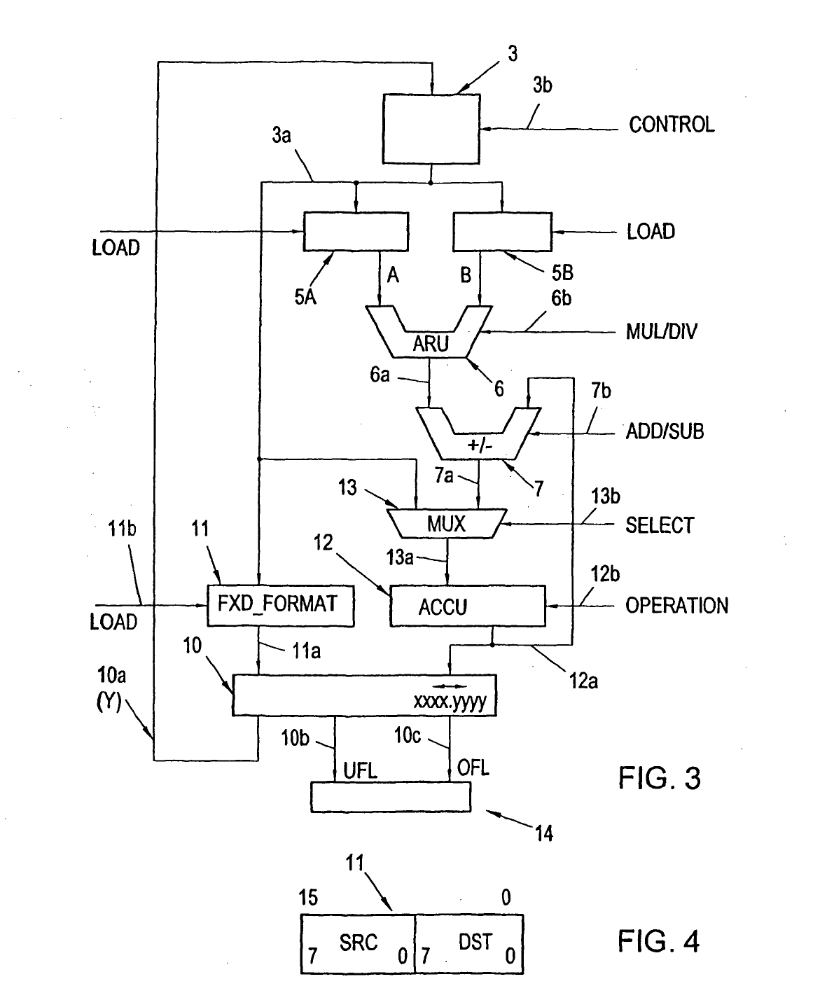

FIG. 3 shows such an arithmetic unit with number format conversion unit in greater detail;

FIG. 4 diagrammatically shows a format of a format register as format specification unit;

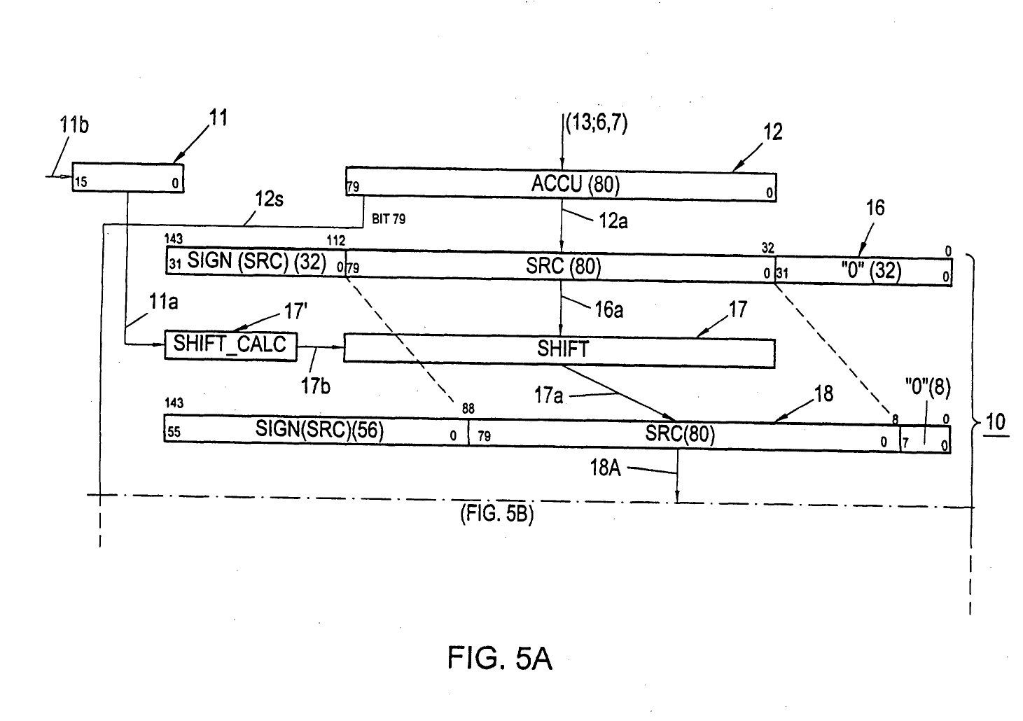

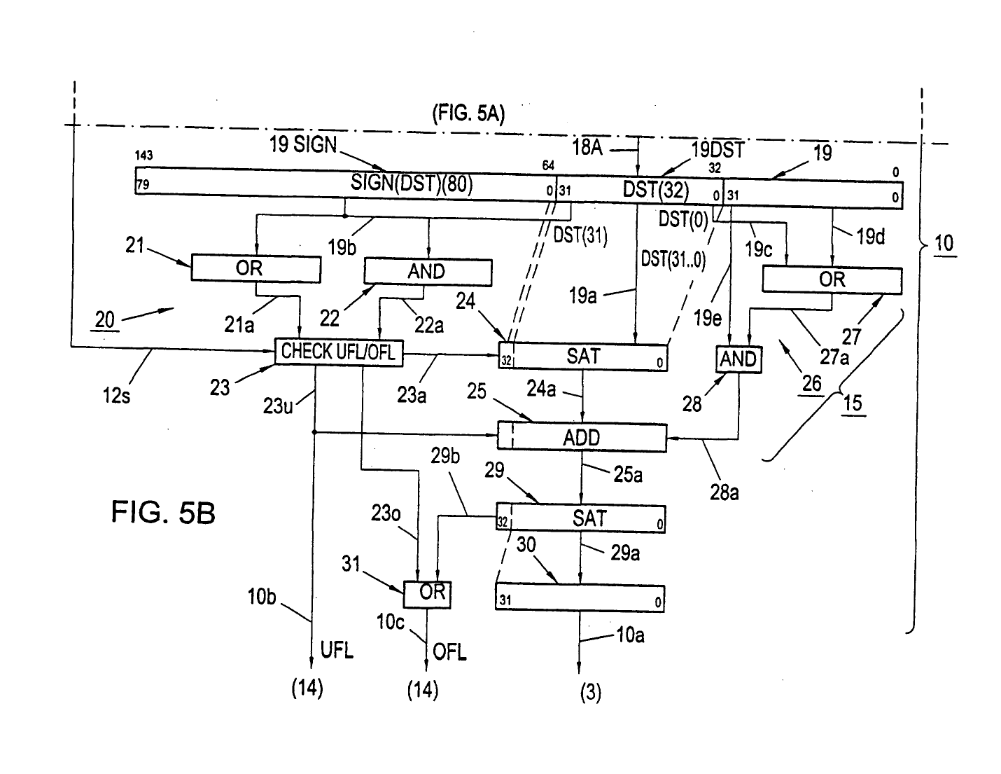

FIG. 5 shows in two associated part-FIGS. 5A and 5B a more detailed configuration of the number format conversion unit plus rounding unit and clipping unit;

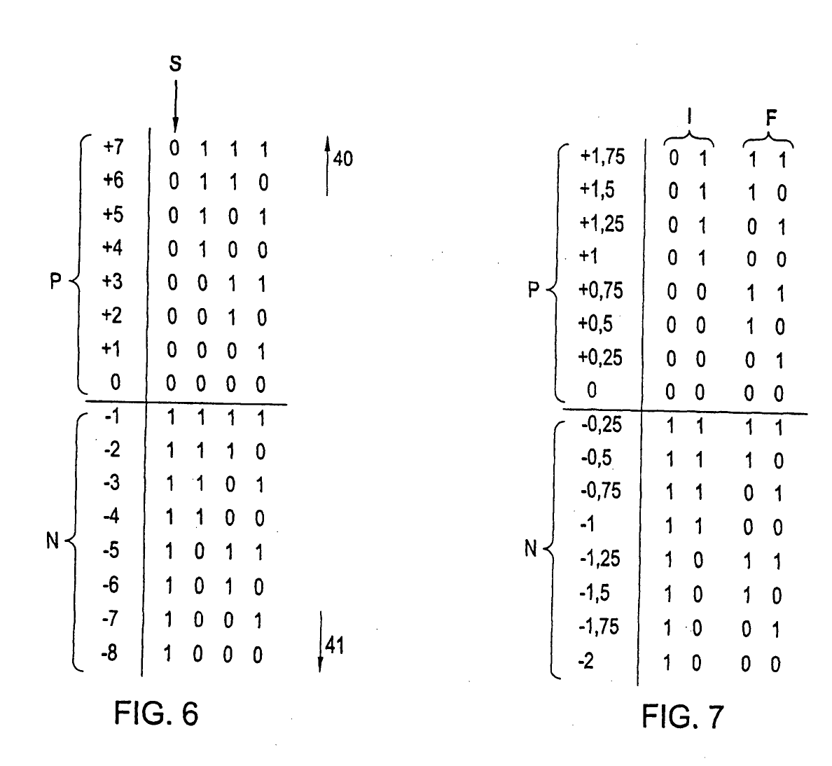

FIG. 6 shows by way of example a table with signed positive and negative 4-bit binary numbers, with a value range from −8 to +7;

FIG. 7 shows a comparable table with 4-bit binary numbers which in each case have two positions before the decimal point and two positions after the decimal point, the values extending from −2 to +1.75;

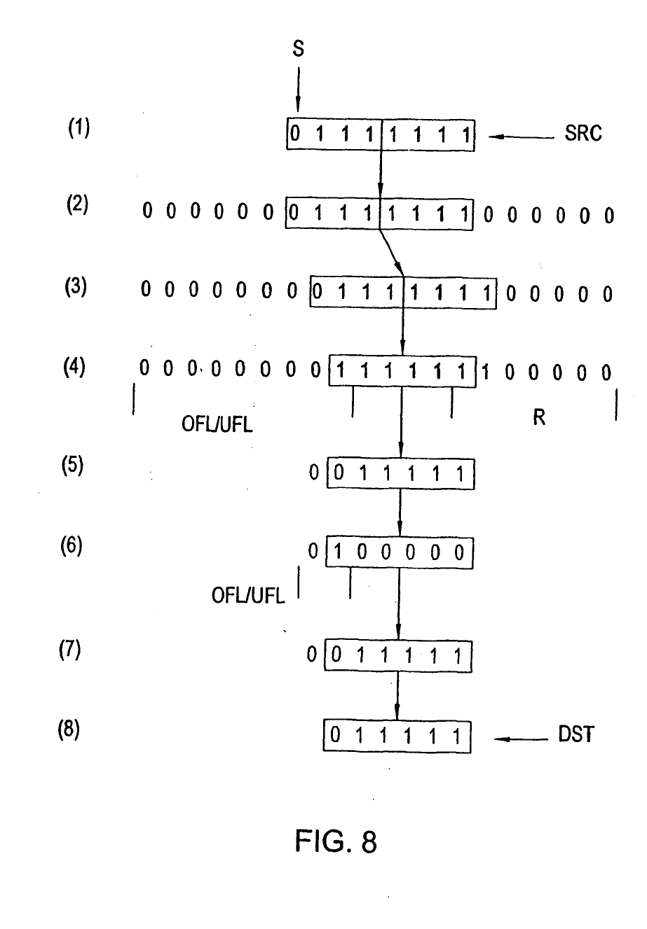

FIG. 8 diagrammatically shows in correlation with the arrangement of FIG. 5 an example of a number format conversion with rounding and clipping, with overflow; and

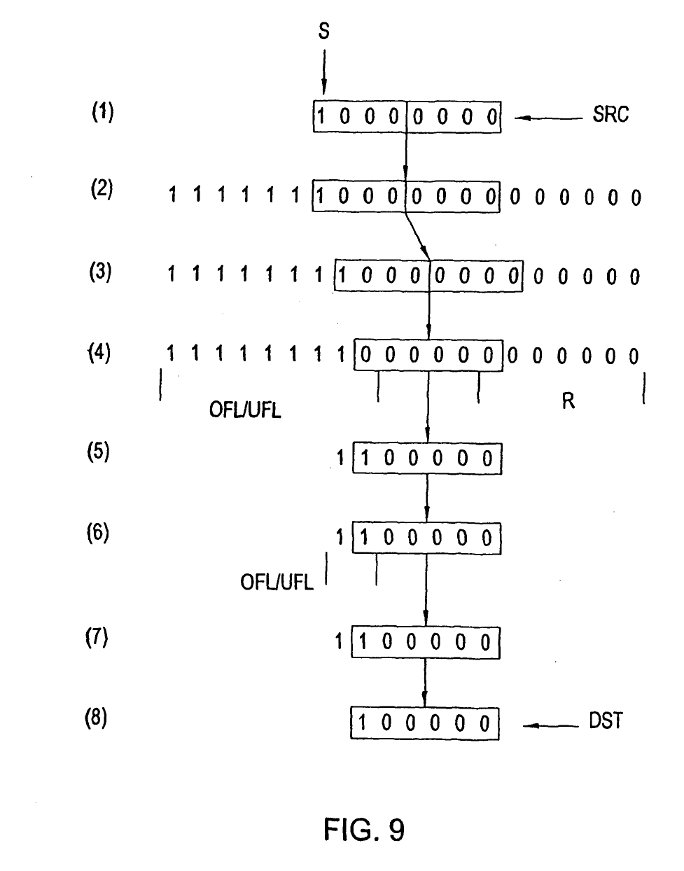

FIG. 9 shows a comparable example of a number format conversion with rounding and clipping, but now with underflow.

FIG. 1 diagrammatically shows in a block diagram the configuration of a processor, known per se, wherein a program memory 1 is provided to which a program controller 2 is connected in order to appropriately drive an arithmetic unit 4 receiving the data to be processed from a data memory 3. The Harvard architecture, as shown, is known for the structure of such arithmetic units 4, as is the Neumann architecture, the further text being based on an arithmetic unit 4 with Harvard architecture even though this is naturally not to be seen as restrictive. The arithmetic unit 4 contains, as will still be explained in greater detail in the text which follows, for example by means of FIG. 3, quite generally an arithmetic unit (ARU) and it defines a data path.

In such a digital signal processor, each program instruction is executed in three phases, the sequence being controlled with the aid of the program controller 2. In the first phase, the so-called “fetch” phase (call up of a command), a command word is read out of the program memory and supplied to the program controller 2 as is illustrated with the reference symbol 1a in FIG. 1. In the subsequent “decode” phase, this command word is decoded and split into individual micro operations with which the arithmetic unit 4 is driven. This is indicated in FIG. 1 with the connection 2a between the program controller 2 and the arithmetic unit 4. In the third phase, the “execute” phase, the instruction is processed and, accordingly, the microoperations are forwarded in the form of control signals via the connection 2a and the arithmetic unit 4 for actual execution in this phase, and, in addition, data are loaded into the arithmetic unit 4 from the data memory 3 via the data connection 3a; In the arithmetic unit 4, these data are computationally processed and temporarily stored in registers. After this processing, the data obtained are stored again in the data memory 3, for example via a connection 4a. To this extent, the data memory 3 forms, for example, input storage means and, at the same time, output storage means for the arithmetic unit 4.

In FIG. 2, the structure of an arithmetic unit 4 is shown in greater detail in a block diagram, data A, B, to be linked to one another, being supplied to, for example, input registers 5A, 5B (e.g. from the data memory 3 according to FIG. 1), which can be considered as input storage means 5, after which the data pass into the arithmetic unit during the processing of the microoperations mentioned, wherein, for example, a multiplier unit 6 is here provided in series with an adder unit 7. The result of these computing operations is normally supplied to output storage means, illustrated diagrammatically here by a result register 8, the result being indicated by “Y”. The individual components 5A, 5B to 8 define a data path 9 and in this data path 9, a number format conversion unit 10 is also directly arranged which, at the same time, contains a rounding unit as will still be explained in greater detail in the text which follows. This number format conversion unit 10 briefly called conversion unit or also alignment unit in the text which follows, can convert the data supplied into a predetermined number format, wherein, as shown in FIG. 2, a format specification unit 11 is provided which, in particular, is constructed in the form of a format register and the output of which is connected to the conversion unit 10 as is indicated in FIG. 2 with the connection 11a. This format specification unit 11 can be filled with corresponding format information for the respective computing process or data processing event, as is indicated diagrammatically at input 11b in FIG. 2.

Arranging the conversion unit 10 immediately in the data path 9 leading from the input registers 5A, 5B to the result register 8 in the manner shown means that the desired format conversions and possibly rounding operations can take place within the same clock cycle in which the computing operations are performed and only a certain delay time having to be accepted until the data occur at the output of the conversion unit 10. This means a temporal acceleration compared with a technique in which the format conversions and rounding operations are performed via the program so that they only take place in each case in subsequent clock cycles, after the actual calculation processes, in separate conversion and rounding steps of the program. The present hardware implementation of these conversion and rounding tasks immediately in the data path 9 also provides for simplification of the programming since in the respective program, which must be stored in the program memory 1 in FIG. 1, simply the desired formats are to be provided for storing in the format specification unit 11 (if these formats cannot be obtained automatically from the start from the memory format of the data memory 3), but no conversion or rounding operations need to be programmed out. Should the delay time mentioned above, which must be taken into consideration in the present technology, be long in comparison with the clock time, e.g. already lasts a half clock cycle, which may be the case in particularly fast arithmetic units 4 with especially short clock cycles, it can be definitely be provided to install a storage element (register) within the conversion unit 10 for buffering so that the format conversion and rounding activity begun in the given clock cycle can be completed in a second clock cycle without the given delay times being able to impair the result of the operations in the arithmetic unit which is stored as result Y in the register 8.

FIG. 3 shows further details for the structure of such a typical arithmetic unit 4 for DSP (digital signal processor) applications. In digital signal processing, an important task is, for example, the so-called multiplier-accumulator (MAC) function. In this function, two input numbers (operands) are multiplied and the result of the multiplication is then added to the content of an accumulator. Such a MAC function is implemented, for example, by means of the arithmetic unit 4 according to FIG. 3, the result obtained also being subjected to an alignment of the range of numbers (number format conversion and rounding). For such functions, the signed 2's complement representation is frequently used for the numbers as will still be explained in greater detail in the text which follows by means of FIGS. 6 and 7, wherein the invention, naturally, should not be restricted to such representations, however. In the subsequent description, however, such a signed 2's complement representation is used as a basis throughout for the sake of simplicity.

According to FIG. 3, the required numbers A, B for the multiplication to be performed are read out of the data memory 3, at the beginning, and loaded into the registers 5A and 5B which is performed by corresponding load commands “LOAD” by the program controller (program controller 2 in FIG. 1). Moreover, the data memory 3 is supplied in a comparable manner with “CONTROL” commands from the program memory 2 via a control line 3b. The data or operands A, B are then supplied to the arithmetic unit 6 in the next step, a corresponding control signal (MUL/DIV—multiply/divide) being applied to it by the program controller 2 at 6b. The result of the multiplication is supplied via the connection 6a to the adder/subtractor 7 which is supplied correspondingly with an adding command (or subtracting command; ADD/SUB) via a control connection 7b by the program controller 2. A second input of this adder/subtractor 7 is supplied from the output of an accumulator 12 with the current content of this accumulator 12 as is indicated in FIG. 3 at 12a. The result of this addition is again stored in the accumulator 12, compare output 7a of adder 7, a multiplexer 13 being interposed which is adjusted by the program controller 2 via a control input 13b (“SELECT”), in such a manner that the multiplexer 13 connects the adding output 7a to the corresponding input of the accumulator 12 (see connection 13a between multiplexer 13 and accumulator 12). The operation of the accumulator 12 is initiated from the program controller 2 by means of a control input 12b (“OPERATION”).

The multiply-accumulate command is usually repeated several times in a loop; as soon as the final result is present in the accumulator 12, it is stored again in the data memory 3 in the present example but first the number format is aligned since the width of the accumulator 12, generally, is greater than the width of the data values A, B read out of the data memory 3. In the present example, the multiplexer 13 is used for loading the accumulator 12 with an initial value from the data memory 3 with a separate instruction at the beginning of the loop. Usually, the value “00” is used as this initial value.

As mentioned, before being stored again in the data memory 3, the content of the accumulator 12 (output 12a) is thus transferred, for the purpose of number format conversion and preferably also for the purpose of any rounding which may be due, to the conversion unit 10 in which the alignment of the number format and the rounding are performed which are still to be described in greater detail in the text which follows by means of FIG. 5. The result is that the computing result corresponds to the predetermined memory format and nevertheless, a greater word width (number width, i.e. a greater number of bits per number) can be used for high accuracy of the calculation for the computing processes performed in the arithmetic unit 4. The conversion unit 10 receives the corresponding control information from the format specification unit 11, preferably a register, which contains control data relating to the format specified in each case (FXD_FORMAT); this control information is loaded a priori at the beginning of the program during an initiation phase in correspondence with the memory format specifications, for example of data memory 3. For example, a value is read directly out of the data memory 3 for this purpose at the beginning of the program, see output 3a in FIG. 3, and loaded into the specification unit 11 with the aid of a control signal 11b (“LOAD”). This word thus specifies the destination format (DST) which the result Y obtained (compare FIG. 2) should have, the format specification unit or register 11, respectively, containing a corresponding area DST, apart from a memory area SRC (source) for corresponding format information with respect to the format used during the calculation in the arithmetic unit 4. The corresponding format information can be 8 bits long in each case in the register 11 (compare bit positions 0-7, overall 0-15, in the specification unit 11 according to FIG. 4).

The format SRC in the specification unit 11 thus relates to the format of the number given at the output of the accumulator 12, the “source number”, whereas the format DST specifies the destination format of the data words for storage in the data memory 3. Each DST or SRC field in the register 11 contains the position of the decimal point in the form of a sign-less binary number, a value of “2” indicating, for example, that the number to be considered should have two decimal places, i.e. two places to the right of the decimal point, so that thus the decimal point is shifted to the left by two positions from the extreme right position.

According to FIG. 3, the conversion unit 10 supplies at its actual output 10a the result (Y; see also FIG. 2) which is stored in output storage means, directly in the data memory 3 according to FIG. 3; in addition, an overflow (OFL) or an underflow (UFL) can also occur during the format conversion and rounding, and corresponding status signals UFL and OFL are present at outputs 10b and 10c of the conversion unit 10; these two status signals UFL, OFL can be supplied preferably to a status register 14 so that they are available for dealing with exceptional cases.

The operation of the conversion unit 10 (format conversion, rounding) will now be discussed in greater detail by means of FIG. 5 and in the text which follows, reference will also be made to FIGS. 6-9. FIG. 5 consists of FIGS. 5A and 5B which must be thought to be joined together along the dashed separating lines in FIGS. 5A and 5B. FIG. 5 contains further, also exemplary dimensional information relating to number of bits or bit widths of the individual data values obtained during the processing, this dimensional information corresponding to normal practical examples. In the text which follows, further explanations will be made by means of actual numerical examples which, however, are simplified, with lower bit numbers, referring especially to FIGS. 8 and 9 for easier understanding, first also explaining 2's complement number representations with regard to “overflow” and “underflow” by means of FIGS. 6 and 7.

As already mentioned, the conversion unit 10, also called ALIGN and ROUND unit (with regard to the format alignment and rounding), is supplied with the output value 12a of the accumulator 12 as can also be seen in FIG. 5, apart from FIG. 3. Thereafter, the format of this output value at the output 12a of the accumulator 12 must be aligned by the conversion unit 10 in accordance with the specification by the register 11 (generally called format specification unit 11) in such a manner that the data word finally obtained (output 10a) is suitable for storage in the data memory 3 (or any other data memory, possibly with another number format). The conversion unit 10 is directly arranged in the data path (see data path 9 in FIG. 2) of the arithmetic unit 4, i.e., in the normal case, the operations performed by the conversion unit 10 are preferably carried out in the same clock cycle as the computing operations in the preceding arithmetic units 6, 7, there being only a slight delay from stage to stage. If, however, extremely short clock cycles are specified and the circuit chips, by means of which the individual components, particularly the conversion unit 10, are implemented, should cause too great a delay by comparison, intermediate storage can be provided, as already mentioned, within the conversion unit 10, possibly also preceding and/or following the conversion unit 10 in order to carry out a first part of the operations in a first clock cycle and a second part of the operations in a second clock cycle. In FIG. 5, however, an intermediate storage unit (particularly register) to be inserted in this manner has not been represented in the drawing since, in the normal case such buffering would not be required and, instead, the computing operations and format conversions can take place in one and the same clock cycle.

The present conversion unit 10 also contains, as an integral hardware component, a rounding unit 15 which consists of individual logic chips and an adder which will still be explained in greater detail in the text which follows; furthermore, a so-called “clipping function” is integrated in order to prevent a sign change from taking place in the case of a number overflow or underflow, see also the statements following in connection with FIGS. 6 and 7.

In the example according to FIG. 5, the accumulator 12 has a width of 80 bits (compare bit positions No. 0-79 in FIG. 5A), and in the conversion unit 10 a conversion into a number with a width of 32 bits is to occur which corresponds to the width of a data word in the data memory 3. For this purpose, the format register 11 also contains a value of 40 in the SCR field (see FIG. 4) and a value of 16 in the DST field, which means that the 80-bit number from the accumulator 12 (the SCR number, that is to say the source number) has its decimal point to the right of bit No. 40 whereas the 32-bit destination number (DST number), after the alignment or conversion process, should have its decimal point to the right of bit No. 16.

At the beginning of the number format alignment or conversion, the 80-bit number is extended on both sides with the aid of an extension unit 16, by 32 bits on the right-hand side, the LSB (least significant bit) side, that is to say by the same number of bits as has the destination word DST, these newly added 32 bits all being set to “0”. On the other, left-hand side, the MSB (most significant bit) side, 32 bits, corresponding to the bit width of the destination word, are also added to the extension, the value of these bits being transferred in accordance with the value of the sign bit which is taken over from the accumulator 12, that is to say the bit at position “79” being selected. This process is also called sign extension, compare also bit field or SIGN (SRC) of the extension unit 16 in FIG. 5A. Overall, a width of 32+80+32=144 bits, from bit No. 0 to bit No. 143, is thus obtained, the bits at positions 32-111 forming the original number at the output 12a of accumulator 12.

Following this, the decimal point of this number extended to a total of 144 bits must now be aligned in such a manner that the decimal point is placed precisely at the required position with regard to the destination number at output 10a of the conversion unit 10. It shall be assumed that bit No. 0 in the source number, that is to say at output 12a of the accumulator 12, is always located to the left of the decimal point as a bit with the value 2⁰, so that this bit is present at position “40” in the source number, and it should be located at position “16” in the destination number (output 10a of the conversion unit 10). Thus, a “shift” by (40−16=) 24 bits to the right (according to the representation in FIG. 5A should take place. This shift is performed with the aid of the shift unit 17 (“SHIFT”), this shifting process to the right (by 24 positions) being illustrated diagrammatically by the oblique representation of its output 17a. At its control input 17b, the shift unit 17 which, for example, can be formed by a multiplexer control block, is supplied with the corresponding control information for this shift by a control unit 17′ calculating the magnitude of the shift. This control unit 17′ calculates the amount of the shift from the values of the format specification register 11 which are present at its output 11a and are supplied to the control unit 17′. The calculated amount of the shift is obtained from the difference between the decimal point positions of the source format (SCR field in register 11) and the destination format (DST field in register 11; see FIG. 4). In real terms, the control unit 17′ can thus consist of a subtractor which forms the difference between the two contents of the fields SRC and DST of the register 11, and it can also be integrated directly into the shift unit 17 as control stage.

In FIG. 5, actually FIG. 5A, the bit chain thus obtained is diagrammatically illustrated by a block 18, dashed oblique lines illustrating that the number originally coming from the accumulator 12 has now been shifted to the right by a corresponding number (namely by 24 bits). During this shift, the bit positions becoming free due to the shift on the left-hand side must be filled up with the correct sign, i.e. bits having the value of the sign bit of the source number (bit No. 79 in accumulator 12) are used for filling up.

If unlike the representation in FIG. 5 a shift to the left is needed (in order to provide a greater number of positions after the decimal point), the bit positions becoming free on the right-hand side are filled with “0” bits.

After this shifting, the decimal point is already at the correct position, corresponding to the one in the destination number, and the destination number can now be taken from the total word—i.e. from the bit chain 18—as part-field in accordance with the desired accuracy. In the present case, the accuracy for the destination number is a result of its positions with 32 bits. The fields of the total word are not changed but only interpreted in the format of the destination number. This can also be called “mask change” and in FIG. 5, this operation is illustrated with the arrow 18a. The result of this is illustrated in FIG. 5 (more precisely 5B) with the part-field unit 19, and it can be seen that the actual number field 19DST (destination) is now 32 bits wide, 80 bits being contained to the left of this in a sign field 19SIGN. On the right-hand side, the bits for the positions to be cut off (positions after the decimal point) are contained at bit positions “0” to “31”, a simple cutting off corresponding to a rounding whereas, under certain conditions as will still be explained in greater detail in the text which follows, a rounding up being performed with the aid of the rounding unit 15. When the bits are taken for the destination number (output 19a), an overflow or underflow of the given range of numbers can take place. Overflow is only possible if the source number was positive and underflow can only take place when the source number was negative.

To recognize any overflow or underflow of the range of numbers, a logic unit 20 is provided which is supplied via a connection 19b with all 80 sign bits of the sign field 19SIGN and the sign bit of the destination word in the destination word field 19DST (bit at position “31”, specified with DST (32) in the drawing) from the output of the part-field unit 19. In the case of a valid number in the part-field unit 19, all sign bits are equal, that is to say either all equal to “0” or equal to “1”. An OR gate 21 is now used to detect whether all bit positions of the sign field have the value “0”, and an AND gate 22 is used to detect whether all bit positions of the sign field have the value “1”. The outputs of these gates 21, 22 are applied to the inputs of a test block 23 which detects an overflow or underflow when the output signal (output 21a) of the OR gate 21 is not equal to “0” or if the output signal 22a of the AND gate 22 is not equal to “1”. The test block 23 then only needs to determine whether there is an overflow or an underflow when the output signal 21a is not equal to “0” or the output signal 22a is not equal to “1”, and this determination is made with the aid of the sign bit of the source number which is contained in the accumulator 12, compare also connection 12s to the test block 23 in FIG. 5. If this sign bit (bit No. “79”) has the value “0”, there is an overflow or an underflow and a—preliminary—overflow signal OFL is activated at the output 23o of the test block 23. If, however, the sign bit has the value “1”, an underflow has occurred and an underflow signal UFL is activated at output 23u of test block 23. This is then also the status signal UFL, already discussed in the description of FIG. 3, at the output 10b of the conversion unit 10.

The result of the evaluation of test block 23 is also delivered via a connection 23a to a clipping unit 24 which is 33 bits wide, that is to say one bit more than the width of the destination number, so that by this means any new overflow after a rounding-addition, still to be described, can be detected.

According to the test evaluation by the test block 23 (output 23a relating to UFL/OFL status), the clipping unit 24 sets the number, supplied at 19a, at its output 24a to the maximum final value in each case. In greater detail, this is the largest positive number in the case of an overflow (OFL), i.e. all bits with the exception of the sign bits (bits No. 31 and 32) are set to “1” in this case, whereas the sign bits at positions 31 and 32 are set to “0”. In the case of an underflow (UFL), the “largest” negative number (i.e. the negative number having the largest absolute amount) is output at output 24a, i.e. all bits in this output number are set to the value “0” with the exception of the two sign bits No. 31 and No. 32 which are set to the value “1”. As already stated, a corresponding underflow signal UFL or overflow signal OFL is additionally output as supplementary signal at outputs 10b and 10c, respectively.

When the least significant bits (to the right of the destination word field l9DST) in the part-field unit 19, that is to say the bits at positions No. 0-31) are cut off, a systematic error is produced, where these errors can be disadvantageously added together and may entail a total malfunction of particular algorithms when the operations described are performed several times (for example if results are accumulated during the implementation of filters). To counteract this, the rounding unit 15 already mentioned is provided which should reduce the systematic errors produced to 0 in the mean. In practice, for example, the so-called IEEE rounding can be used (compare, for example, IEEE Standard for Binary Floating Point Arithmetic IEEE 754-1985). In this rounding, rounding up is only performed when, in addition to a “1” bit at position No. 31, at least one “1” bit occurs somewhere at the positions after the decimal point (in this case bit positions No. 0-31) (a single such additional “1” bit is sufficient), or if only bit No. 31 has the value 1, and if the LSB bit in the destination word field 19DST also has the value “1”. Such rounding up means that a “1” (generally the smallest positive value) is added to a number obtained at the output of the clipping unit 24 with the aid of an adder 25. A logic unit 26 with an OR gate 27 and an AND gate 28 detects whether such rounding (rounding up to be precise) must actually be performed. For this purpose, the least significant bit (LSB bit) from the destination word field 19DST (see connection 19c) and the bits cut off (see connection 19d) are applied to the OR gate 27, the output 27a, like bit No. 31 of the least significant bits cut off (see output 19a) being applied to the AND gate 28. The IEEE rounding mentioned provides for rounding up, that is to say adding a “1” in the adder 25 (output “1” of the AND gate 28, connection 28a), if any bit 19d or 19c is set to 1 and, at the same time, bit 19e (bit No. 31 of the part-field unit 19) also has the value 1.

However, such rounding-up only occurs if the test block 23 has not found any underflow (signal UFL), i.e. the adder 25 is also connected to the output 23u of the test block 23 with one input. If such an underflow has not been found and rounding up is to be performed, the adder 25 adds the smallest possible positive number to the result at the output 24a of the clipping unit 24.

Since such rounding up can again lead to an overflow (OFL), a further clipping unit 29 is connected to the output 25a of the adder 25 and this clipping unit 29 limits the output result (the destination word) to the highest possible numerical value in the same manner as described before with reference to the clipping unit 24. This highest possible numerical value is output at the output 29a and stored in a register 30. If there is no overflow, the number obtained from the adder 25 is directly written into the register 30. In the case of an overflow, a corresponding OFL signal is output at output 29b of the clipping unit 29 and this OFL signal is combined in accordance with an OR function (see OR gate 31 in FIG. 5b) with the OFL signal at the output 23o of test block 23 so that a corresponding OFL signal is obtained at output 10c of the conversion unit 10 also in the case of only one overflow.

The above shows that in the case where there is no overflow or underflow of the number during the reduction to the part-field (see part-field unit 19), units 24, 25 and 29 remain functionless and the output number 19a of the part-field unit 19 passes directly to the register 30 (as output storage means), where it is stored.

This concludes the number format conversion and any rounding and the end result, i.e. the destination number DST, with the desired bit width (corresponding to the bit width of the destination number field 10DST of the part-field unit 19) can now be written into the general data memory 3 again as result Y as previously explained especially with reference to FIGS. 1 and 3. On the other hand, the status signals UFL and OFL are loaded into the status register 14 (compare FIG. 3).

To complete the description, the so-called 2's complement representation of the binary numbers will now be explained briefly as an example with reference to FIGS. 6 and 7 since this 2's complement representation has been used as a basis for the operations according to FIG. 5. In FIG. 6, 4-bit binary numbers provided with a sign bit S are illustrated in a table, the range of values extending from −8 to +7 in this example. The positive numbers are shown at P and the negative ones at N. As can be seen, the number is positive if the sign bit S has the value “0” (the number 0 should also be counted in the positive numbers), if, in contrast, the sign bit S is “1”, the number is a negative number N. In adding or subtracting, the case may occur where the result exceeds or drops below the limits of the range of numbers, compare arrows 40 and 41 in FIG. 6. In the case of an addition of a positive number to a positive number, for example (compare arrow 40), the range P of positive numbers can be exceeded (“overflow”) so that a negative number “is produced”, since bit word “0111” (for the number +7) is followed by the number “1000” in the binary number representation shown which, however, is already the largest negative number (−8). Similarly, a positive number can be produced if a negative number is added to a negative number (by amount) (see arrow 41 in FIG. 6) (namely with a “0” at the place of the sign bit S) so that an underflow or undershoot of the range of values is obtained.

FIG. 7 also shows 4-bit binary numbers with a sign (again in column 1 of the bits), with integral components I (integer), and two positions after the decimal point F (fraction), the range of values of these binary numbers extending from −2 to +1.75. Using the IEEE rounding, mentioned above with reference to FIG. 5, as a basis, rounding up to +1, +2 or +2 will occur, for example, with numbers +0.75, +1.5 and +1.75, respectively, if the positions after the decimal points are cut off; but no rounding up will be performed with the number +0.5. This is because with this IEEE rounding, the number 0.5 is rounded down and 0.51 is already rounded up, similarly, the number 1.5 is rounded up but not the number 2.5 but again number 3.5 etc.

FIGS. 8 and 9 show examples with format conversion and rounding, once with an overflow (FIG. 8) and once with an underflow (FIG. 9) illustrated in the form of simplified bit representations (with much smaller bit widths in comparison with FIG. 5) shown in rows (1) to (8).

In detail, row 1 in FIG. 8 shows an 8-bit source number SRC which contains an integral 4-bit component and 4-bits after the decimal point. The bit farthest to the left in the integral components is the sign bit S. The destination number DST shown in row 8, in contrast, consists of 6 bits, the first three bits representing the integral components including the sign bit and the further three bits representing the positions after the decimal point. The value of the source number SRC is +7.9375 which in this case corresponds to the largest value that can be represented.

According to row (2), an extension is effected to the left of the sign bit S, the same number (namely six) of bits (in this case “0” bits) as the number of bits of the destination number DST being placed in front. At the same time, exactly the same number of “0” bits (i.e. six “0” bits) is appended to the right of the source number SRC.

For this shift now required, the difference between the number of trailing positions of the source number SRC and that of the destination number DST must be calculated (which is handled by the control unit 17 according to FIG. 5) and this difference is “1” in the example of FIG. 8, i.e. the bit chain is shifted to the right by one position, see row (3) in FIG. 8; the left-hand side being filled with the value of the sign bit, i.e. a “0” bit is added here in the actual case. In the end, a new mask, now having only six positions, according to the number of bits of the destination number DST, is placed over this chain according to row (4) in FIG. 8. This mask can be recognized in FIG. 8 by a shorter block (in comparison with rows (1) to (3)) . As can be seen, the six-bit number in row 4 of FIG. 8 thus becomes negative (“1” bit in the position to the extreme left). The nine bits to the left of this (including the sign bit of the destination number) are now checked for equality and since they are not all equal, an underflow/overflow condition is found, compare logic unit 20 in FIG. 5. To determine precisely whether it is an overflow or an underflow, the sign bit of the source number SRC is used; this sign bit has the value “0” in the present case so that an overflow (OFL) is found. If the sign bit of the source number SRC had the value “1”, an underflow would be found. Using the clipping unit 24 (FIG. 5), the destination word DST now receives the highest positive value as can be seen from row 5 in FIG. 8, this value now being +3.875. The rounding unit 15 (see FIG. 5) recognizes the necessity of rounding up at R in FIG. 8, the rounding unit 15 using for this purpose the seven bits farthest to the right. Accordingly, the destination number DST is incremented by the value 0.125 (the smallest value which can be represented with three bits), this addition value being shown in row 6 of FIG. 8, but the highest positive value which is obtained by the clipping unit 24 being shown in row 5.

With this addition of numbers, a negative number is again obtained, compare row 6 in FIG. 8, which is detected by the second clipping unit 29 (see FIG. 5). The destination number is, therefore, set again to the greatest possible value which is shown in row 7 of FIG. 8, and the number thus obtained is forwarded as final destination number DST to the register 30 (see FIG. 5), which is illustrated in row 8 of FIG. 8. At the same time, a corresponding overflow signal OFL is also delivered to the status register 14 (see FIG. 3).

In the example in FIG. 9, the source number SRC is again an 8-bit number with a sign bit S and four bits trailing digits, the source number SRC shown having the greatest negative value (by amount), namely −4.000. The destination number should again have six bit positions and in accordance with this number of bits, the sign bits are extended by six “1” bits on the left-hand side according to row 2 of FIG. 9, whereas the bits on the right-hand side are filled with “0”. This is again followed by a shift of the chain by one position to the right—see row 3 of FIG. 9—a “1” bit now being inserted on the left-hand side. When the mask is changed, according to row 4 in FIG. 9, in order to reduce the number of bits to six bits according to the number of bits of the destination number DST, it can be seen that the number has now assumed a positive value (the left-hand bit, the sign bit, has the value “0”) and, furthermore, it is also found during the overflow/underflow test that the nine bits on the left-hand side are not equal. Since this is detected as an underflow, the number is, therefore, set to the largest negative value, compare row 5 in FIG. 9. (In this example, a check for overflow or underflow (OFL/UFL) shows that an underflow is present since the sign bit S of the source number SRC has the value “1”.)

In the case of an underflow, however, the adder 25 cannot add a possible rounding result to the destination number, i.e. the number remains the same at the output of the adder 25, compare row 6 in FIG. 9. The further clipping unit 29 then does not detect an overflow or underflow (row 7 in FIG. 9) and forwards the numerical value unchanged to the following register 30, compare row 8 in FIG. 9.

In practice, the configuration described especially with reference to FIG. 5, can be preferably implemented in combinatorial logic (i.e., in particular, by means of AND and OR gates and with multiplexer chains for shifting etc.) without providing storing elements (registers) between them. The result is that in the same clock cycle in which the computing operations are performed, the format alignments and any rounding operations can also be performed. If very short clock times are to be implemented, storage elements (registers) can also be provided between the individual units as already mentioned.

In the preceding text, IEEE rounding has been explained as an example in connection with the rounding. Naturally, however, other types of roundings are also conceivable in the context of the invention such as, for example, business rounding, mere cutting-off of the last positions and other known types of rounding. The only factor of significance here is that the corresponding logic is implemented in hardware instead of providing programming for the arithmetic unit 4.

1-11. (canceled)

12. A digital signal processing device, comprising:
input memory means;
a computing device connected to said input memory means and defining a data path, said computing device having at least one arithmetic unit and a control input for specifying computing operations;
output memory means;
a number format conversion unit connected in the data path between said arithmetic unit and said output memory means, said number format conversion unit having a shift unit; and
a number format presetting unit and a control unit connected to said number format presetting unit associated with said number format conversion unit for calculating shift operations required on a basis of a number format specification, wherein formatting operations are calculated automatically from input and output format information and corresponding commands are applied to said shift unit.

13. The digital signal processing device according to claim 12, wherein said control unit is a subtractor.

14. The digital signal processing device according to claim 12, wherein said control unit is integrated in said shift unit.

15. The digital signal processing device according to claim 12, wherein said number format presetting unit is a register.

16. The digital signal processing device according to claim 12, wherein said number format conversion unit comprises an extension unit extending a width of an input number, and said shift unit connected to said extension unit is configured to shift bits of an extended input number by a predetermined amount.

17. The digital signal processing device according to claim 12, which further comprises a part-field unit connected to said shift unit.

18. The digital signal processing device according to claim 17, wherein said part-field unit comprises a sign field connected to a logic unit for detecting whether the sign field contains only “0” or only “1” or whether different sign bit positions are present, and wherein an “only zeros” state corresponds to an overflow and an “only ones” state corresponds to an underflow.

19. The digital signal processing device according to claim 18, wherein said logic unit contains an OR gate for detecting the “only zeros” state and an AND gate for detecting the “only ones” state.

20. The digital signal processing device according to claim 18, which further comprises a saturation unit connected to said logic unit and said part-field unit, said saturation unit setting a number output of said part-field unit to a largest positive number in a case of an overflow and to a largest negative number in a case of an underflow.

21. The digital signal processing device according to claim 18, wherein said number format conversion unit is combined with a rounding unit containing an adder, and said adder is connected to said part-field unit via a logic unit.

22. The digital signal processing device according to claim 21, wherein said rounding unit and said saturation unit are connected to a further saturation unit, and said further saturation unit is configured to set a result number to a largest positive number in an event of an overflow taking place with a rounding-up and, at a same time, to output an overflow signal.

23. The digital signal processing device according to claim 20, wherein said rounding unit and said saturation unit are connected to a further saturation unit, and said further saturation unit is configured to set a result number to the largest positive number in an event of an overflow taking place with a rounding-up and, at a same time, to output an overflow signal.
